(19) United States
(12) Patent Application Publication
(10) Pub. No.: US 2011/0309691 A1
(43) Pub. Date: Dec. 22, 2011

(54) Linear vibrator and electronic device having the same

(75) Inventors: Seok Jun Park, Suwon (KR); Joon Choi, Suwon (KR); Jun Kun Choi, Suwon (KR); Hwa Young Oh, Seoul (KR)

(73) Assignee: SAMSUNG ELECTRO-MECHANICS CO., LTD., Suwon (KR)

(21) Appl. No.: 12/926,478

(22) Filed: Nov. 19, 2010

(30) Foreign Application Priority Data
Jun. 16, 2010 (KR) 10-2010-0057089

(51) Int. Cl. H02K 33/02

(52) U.S. Cl. 310/25

(57) ABSTRACT

There is provided a linear vibrator including a housing providing an internal space; a magnetic field part having a yoke disposed in the internal space and a magnet magnetized on a surface of the yoke and vibrating in the internal space by an interaction with a coil to which power is applied; an elastic member connecting the yoke and the housing and allowing the magnetic field part to be elastically supported in the internal space; and a magnetic flux collecting part collecting magnetic flux of the magnetic field part and allowing the magnetic field part to move towards the coil.

### CROSS-REFERENCE TO RELATED APPLICATIONS

This application claims the priority of Korean Patent Application No. 10-2010-0057089 filed on Jun. 16, 2010, in the Korean Intellectual Property Office, the disclosure of which is incorporated herein by reference.

### BACKGROUND OF THE INVENTION

1. Field of the Invention

The present invention relates to a linear vibrator and an electronic device having the same, and more particularly, to a linear vibrator preventing or rapidly removing minute vibrations that may be caused by external impacts and an electronic device having the same.

2. Description of the Related Art

A linear vibrator is a device transforming electrical energy into mechanical vibrations using a principle of generating electromagnetic force. The linear vibrator is mounted on an electronic device such as a mobile communication terminal, a game machine, or the like, for soundless call reception notification and vibration transfer.

In recent years, a mobile communication terminal has been small and slim, and the linear vibrator mounted thereon has also been reduced in size and improved in functionality.

A linear vibrator according to the related art has an internal space including a stator and a vibrator vibrating by electromagnetic interaction.

Since internal components forming the vibrator and the stator are disposed in the internal space in such a manner as to realize a high-density configuration, there is interference between the internal components due to the vibrations of the vibrator.

Also, when an impact is applied to the linear vibrator, the vibrator hung within the internal space makes repeated contact and non-contact with the other components to thereby cause minute vibrations.

Therefore, research into a linear vibrator capable of removing minute vibrations, even if the high-density internal space thereof has been realized, is necessary.

### SUMMARY OF THE INVENTION

An aspect of the present invention provides a linear vibrator including a magnetic flux collecting part. The magnetic flux collecting part is fixed to a coil providing a vibrating space, in which a magnet vibrates while being supported by an elastic member, and collects the magnetic flux of magnetic fluid provided between the magnet and the coil.

An aspect of the present invention also provides an electronic device having the linear vibrator mounted thereon.

According to an aspect of the present invention, there is provided a linear vibrator including: a housing providing an internal space; a magnetic field part having a yoke disposed in the internal space and a magnet magnetized on a surface of the yoke and vibrating in the internal space by an interaction with a coil to which power is applied; an elastic member connecting the yoke and the housing and allowing the magnetic field part to be elastically supported in the internal space; and a magnetic flux collecting part collecting magnetic flux of the magnetic field part and allowing the magnetic field part to move towards the coil.

The linear vibrator may further include a coil damping portion provided between the coil and the magnet and relieving an impact generated when the magnetic field part and the coil are in contact with each other due to magnetic action of the magnetic flux collecting part.

The coil damping portion may include a magnetic fluid band formed along an outer surface of the magnet.

The coil may be wound so as to form a space in which the magnetic field part vibrates and moves, and the magnetic flux collecting part may be provided on the coil.

The magnetic flux collecting part may include a metallic piece and may be adhesively fixed to an upper portion or inner circumferential surface of the coil.

The coil may be shaped as a cylinder so as to form a space in which the magnetic field part vibrates and moves, and the magnetic flux collecting part may include a plurality of metallic pieces formed on a ring-shaped rim portion fixed to the coil.

The magnetic flux collecting part may include magnetic powder and may be adhesively fixed to an upper portion or inner circumferential surface of the coil.

The magnetic flux collecting part may include magnetic liquid and may be adhesively fixed to an upper portion or inner circumferential surface of the coil.

The coil may be shaped as a cylinder so as to form a space in which the magnetic field part vibrates and moves, and the magnetic flux collecting part may be forcibly fitted around the coil.

The yoke may include a magnet fixing portion having the magnet fixed thereto; a mass body fixing portion bent from the magnet fixing portion in a direction in which the magnet is magnetized and having a mass body fixed thereto; and a claw portion bent from the mass body fixing portion and supporting a lower portion of the mass body.

The housing may include an upper case shaped as a cylinder having an open lower portion; and a bracket sealing the lower portion of the upper case and having the coil magnetized thereon.

The magnetic field part may further include a yoke plate fixed to a surface of the magnet opposite to a surface thereof in contact with the yoke and preventing magnetic leakage.

The housing may include a bracket damper on a surface thereof, the bracket damper preventing the magnetic field part from making contact with the housing due to vibrations of the magnetic field part.

According to another aspect of the present invention, there is provided a linear vibrator including: an upper case shaped as a cylinder having an open lower portion; a bracket fixed to the open lower portion of the upper case to form an internal space and having a coil fixed thereto, the coil receiving power applied thereto from an external source; a magnetic field part including a yoke disposed in the internal space, a magnet magnetized on a surface of the yoke, and a yoke plate provided on a surface of the magnet opposite to a surface thereof in contact with the yoke, and vibrating in a space within the coil; an elastic member connecting the upper case and the yoke and allowing the magnetic field part to be elastically supported in the internal space; and a magnetic flux collecting part collecting magnetic flux of the magnetic field part while breaking a balance of the magnetic flux from the magnetic field part to the coil, and provided on part of an upper portion or inner surface of the coil.

The linear vibrator may further include a magnetic fluid band provided along an outer surface of the magnet and relieving an impact generated when the magnetic field part and the coil are in contact with each other due to magnetic action of the magnetic flux collecting part.

The magnetic flux collecting part may include a metallic piece adhesively fixed to the coil.

The magnetic flux collecting part may include a plurality of metallic pieces formed on a ring-shaped rim portion fixed to the coil, and the metallic pieces may cause eccentricity in the magnetic flux.

The magnetic flux collecting part may include magnetic powder adhesively fixed to the coil.

The magnetic flux collecting part may include magnetic liquid fixedly applied to the coil.

The magnetic flux collecting part may include a metallic piece forcibly fitted around the coil.

The yoke may include a magnet fixing portion having the magnet fixed thereto; a mass body fixing portion bent from the magnet fixing portion in a direction in which the magnet is magnetized and having a mass body fixed thereto; and a claw portion bent from the mass body fixing portion and supporting a lower portion of the mass body.

The linear vibrator may further include a bracket damper provided on the bracket so as to prevent the magnetic field part from making contact with the bracket due to vibrations of the magnetic field part.

According to another aspect of the present invention, there is provided an electronic device including: the linear vibrator; a circuit board having the linear vibrator mounted thereon; and a case having the circuit board in an internal space thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view schematically illustrating a linear vibrator according to an exemplary embodiment of the present invention;

FIG. 2 is a schematic cross-sectional view illustrating the linear vibrator of FIG. 1;

FIG. 3 is an enlarged cross-sectional view of portion A of FIG. 2;

FIG. 4 is a plan view illustrating the linear vibrator of FIG. 1 with the exception of an upper case and a magnetic field part;

FIG. 5 is a schematic perspective view illustrating an elastic member according to an exemplary embodiment of the present invention;

FIG. 6 is a plan view of the linear vibrator of FIG. 1 to which a first modified example of a magnetic flux collecting part provided on a coil is applied;

FIG. 7 is an enlarged cross-sectional view of portion A of FIG. 2 illustrating a second modified example of the magnetic flux collecting part provided on the coil;

FIG. 8 is an enlarged cross-sectional view of portion A of FIG. 2 illustrating a third modified example of the magnetic flux collecting part provided on the coil;

FIG. 9 is a schematic cross-sectional view illustrating a phenomenon in which magnetic flux generated in a magnetic field part is collected in a magnetic flux collecting part; and

FIG. 10 is an exploded perspective view schematically illustrating an electronic device including a linear vibrator according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to designate the same or like elements.

Linear Vibrator

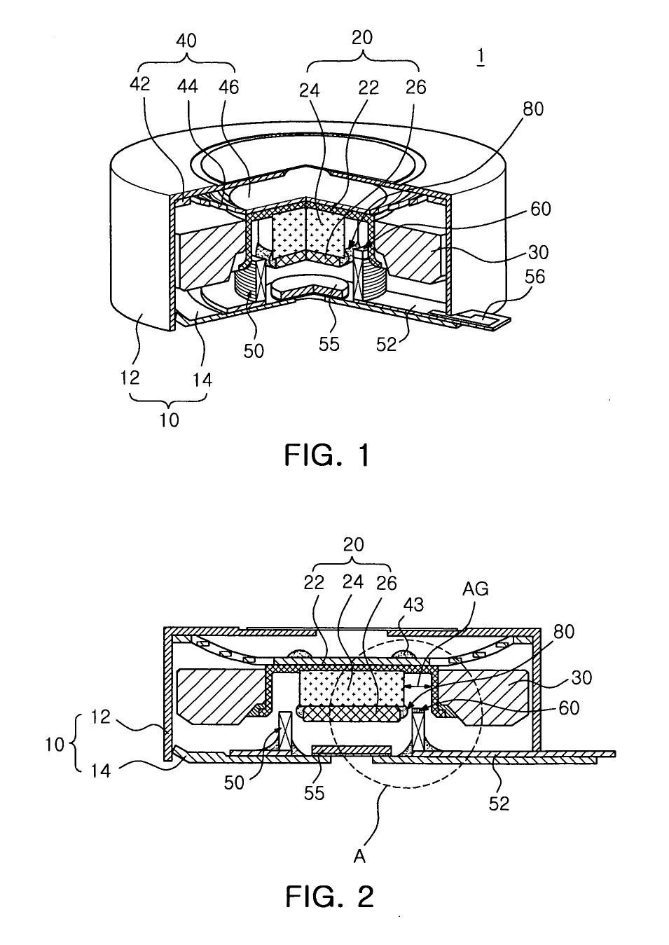

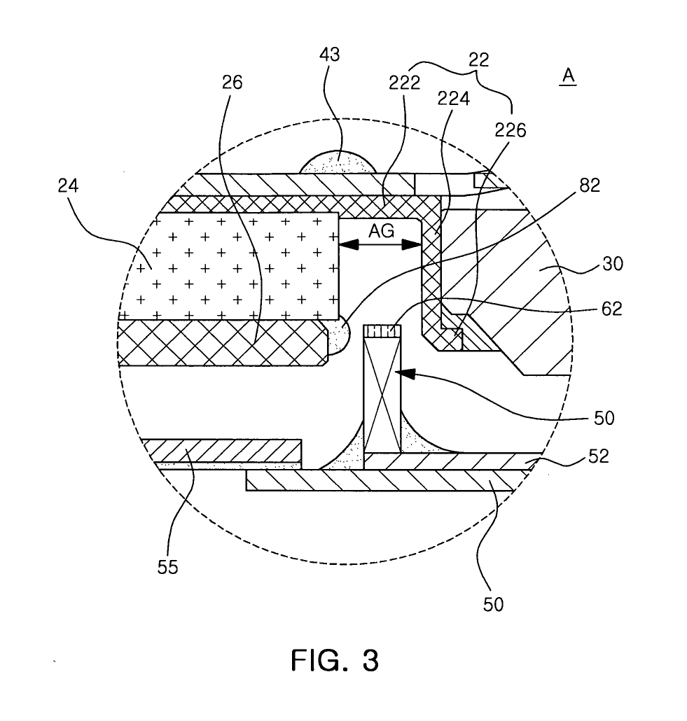

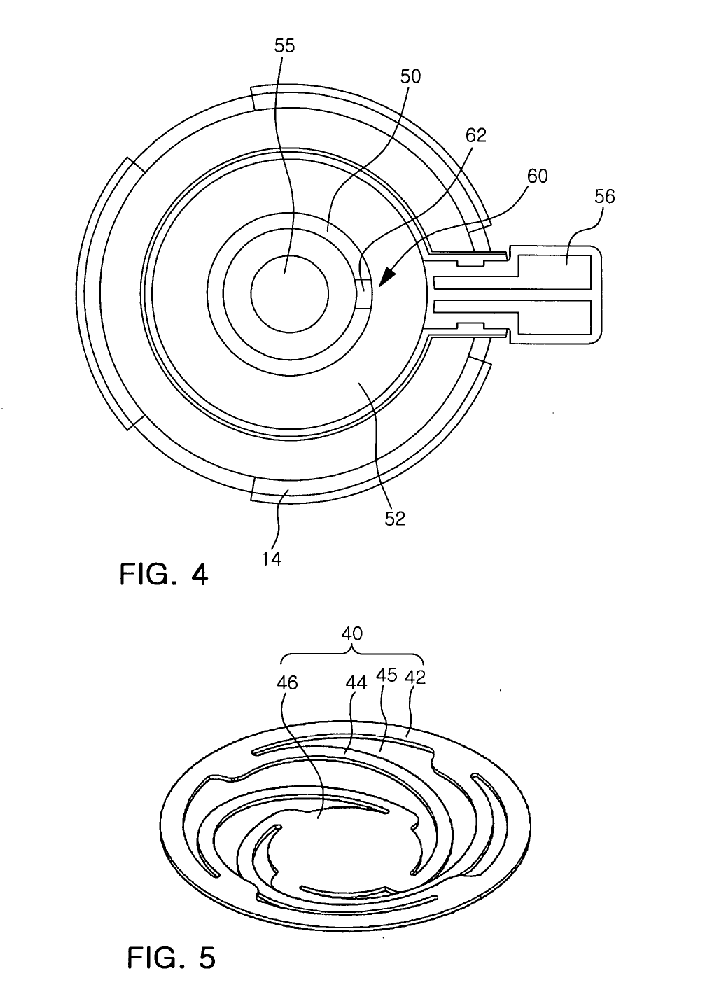

FIG. 1 is a partially cut-away perspective view schematically illustrating a linear vibrator according to an exemplary embodiment of the present invention. FIG. 2 is a schematic cross-sectional view illustrating the linear vibrator of FIG. 1. FIG. 3 is an enlarged cross-sectional view of portion A of FIG. 2. FIG. 4 is a plan view illustrating the linear vibrator of FIG. 1 with the exception of an upper case and a magnetic field part. FIG. 5 is a schematic perspective view illustrating an elastic member according to an exemplary embodiment of the present invention.

With reference to FIGS. 1 through 5, a linear vibrator 1 according to an exemplary embodiment of the invention may include a housing 10, a magnetic field part 20, an elastic member 40 and a magnetic flux collecting part 60.

The housing 10 may have an internal space in which internal components are disposed. The housing 10 may be configured in various manners. Particularly, the housing 10 should allow the internal components to be easily arranged and assembled therein.

The housing 10 in the present embodiment may include an upper case 12 having the form of a cylinder of which a lower portion is open, and a bracket 14 sealing the lower portion of the upper case 12 and having a coil 50 magnetized thereon.

A printed circuit board 52 may be mounted on the bracket 14. The printed circuit board 52 may be manufactured as a flexible printed circuit board (FPCB).

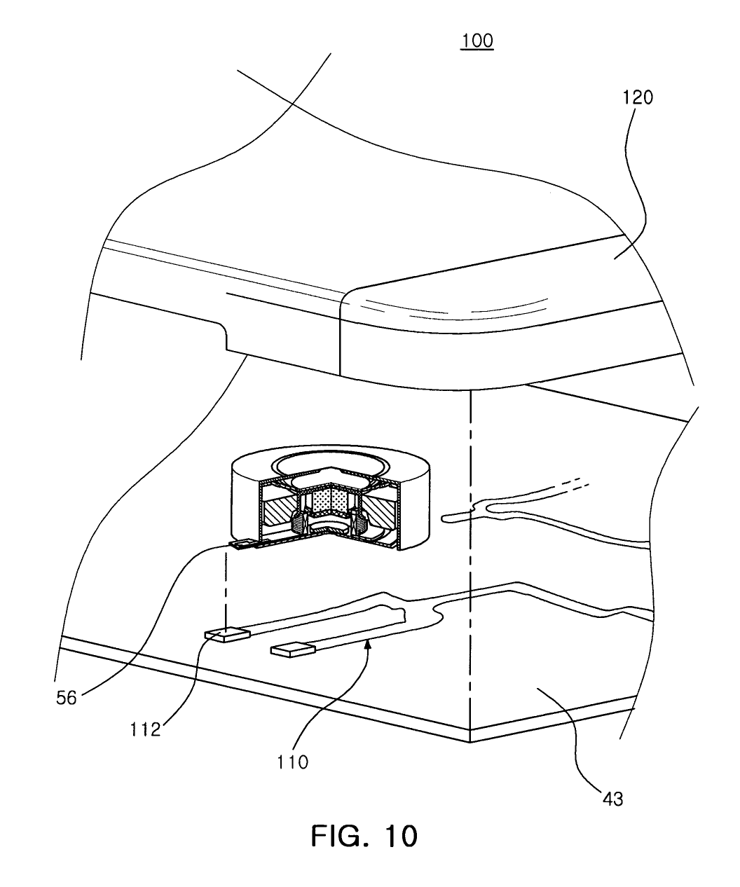

The printed circuit board 52 may include a connection terminal portion 56 allowing the linear vibrator 1 to be connected to a circuit board 110 of an electronic device 100 of FIG. 10.

The magnetic field part 20 may generate a magnetic field of a certain strength and have a yoke 22 and a magnet 24 disposed in the internal space of the housing 10. The magnet 24 is coupled with a yoke plate 26 on a surface of the magnet 24 opposite to a surface thereof in contact with the yoke 22 to prevent magnetic leakage.

The yoke 22 may have the form of a cylinder of which a top portion is sealed and a lower portion is open. Specifically, the yoke 22 may include a magnet fixing portion 222 having the magnet 24 fixed thereto, a mass body fixing portion 224 bent from the magnet fixing portion 222 in a direction in which the magnet 24 is magnetized and having a mass body 30 fixed thereto, and a claw portion 226 bent from the mass body fixing portion 224 and supporting a lower portion of the mass body 30.

The yoke 22 and the magnet 24 may be fixed in a manner such that the magnet 24 is bonded onto a surface of the yoke 22 by an adhesive.

An inner circumferential surface of the yoke 22 has a diameter larger than an outer circumferential surface of the magnet 24. An air gap AG of a certain size may be formed between the inner circumferential surface of the yoke 22 and the outer circumferential surface of the magnet 24.

The coil 50 may be disposed in the air gap AG and may allow current to flow in the magnetic field generated by the magnetic field part 20 to thereby cause the magnetic field part 20 to vibrate.

The coil 50 may have the form of a cylinder in which a space for the movement of the magnetic field part 20 is formed. That is, the coil 50 may be wound while allowing for the formation of the space in which the magnetic field part 20 vibrates and moves. Further, a coil damping portion 80 may be provided in a gap between the magnetic field part 20 and the coil 50 so as to relieve an impact when the magnetic field part 20 and the coil 50 are in contact with each other.

The coil damping portion 80 may be a magnetic fluid band 82 formed along an outer surface of the magnet 24.

A bracket damper 55 may be formed on the upper surface of the bracket 14 to prevent the magnetic field part 20 from making contact with the housing 10 due to the vibrations of the magnetic field part 20. The bracket damper 55 may be modified to have various shapes, and the bracket damper 55 may be formed of rubber.

The elastic member 40 may be a spring member such as a plate spring or a coil spring. The elastic member 40 may include a housing fixing portion 42 fixed to a surface of the upper case 12, a yoke fixing portion 46 being in contact with a surface of the yoke 22 opposite to the surface thereof in contact with the magnet 24, and a plurality of connection strip portions 44 disposed to form an elastic space 45 between the housing fixing portion 42 and the yoke fixing portion 46.

The housing fixing portion 42 is a stationery portion of the elastic member 40, which is fixed to the non-vibrating housing 10. The yoke fixing part 46 is a free portion of the elastic member 40, which vibrates due to the vibrations of the magnetic field part 20.

In order to relieve an impact generated when the magnetic field part 20 installed in the free portion of the elastic member 40 makes contact with the upper surface of the elastic member 40 due to the vibrations of the magnetic field part 20, an upper case damper 43 may be installed in at least one of upper and lower portions of the elastic member 40.

The upper case damper 43 may include magnetic fluid and be fixed to the upper surface of the elastic member 40 by leakage flux of the magnet 24.

The yoke fixing portion 46 may be a flat circular plate, and the housing fixing portion 42 may be a ring-shaped rim portion having an opening in the center thereof. The connection strip portion 44 may have a spiral shape allowing for the connection between the yoke fixing portion 46 and the housing fixing portion 42.

The magnetic flux collecting part 60 collects the magnetic flux of the magnetic field part 20 and allows the magnetic field part 20 to move towards the coil 50. That is, the magnetic flux collecting part 60 disturbs the balance of the magnetic flux between the magnetic field part 20 and the coil 50. In order to break the balance of the magnetic flux from the magnetic field part 20 to the coil 50, the magnetic flux collecting part 60 may collect part of the magnetic flux of the magnetic field part 20.

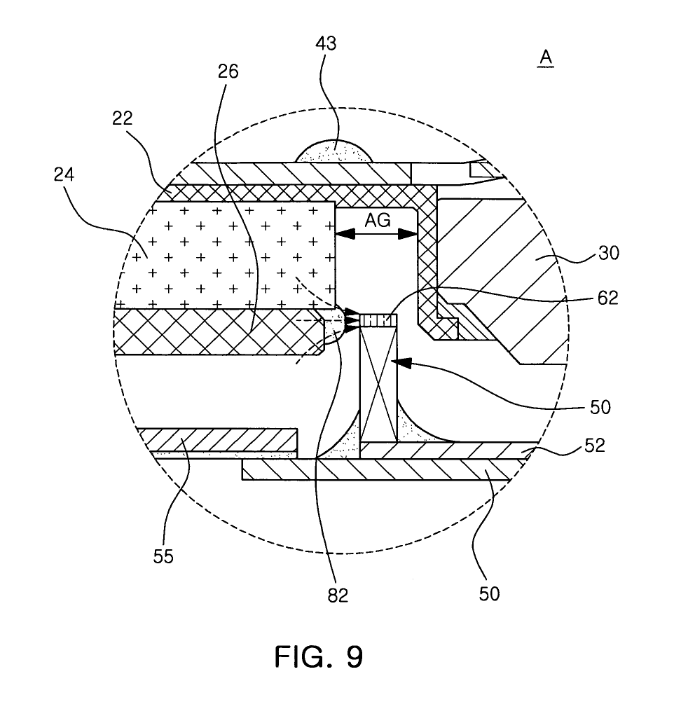

FIG. 9 is a schematic cross-sectional view illustrating a phenomenon in which the magnetic flux generated in the magnetic field part is collected in the magnetic flux collecting part. With reference to FIG. 9, it is better understood that the magnetic flux of the magnetic field part 20 is collected in the magnetic flux collecting part 60 provided on the coil 50.

The magnetic flux collecting part 60 may be installed in anyplace affecting the magnetic flux of the magnetic field part 20. The magnetic flux collecting part 60 may be installed in the internal space by the use of a separate member, or may be installed on a structure present in the outside of the magnetic field part 20.

Here, the magnetic flux collecting part 60 may be provided on part of the upper portion or inner surface of the coil 50 present in the outside of the magnetic field part 20.

The magnetic flux collecting part 60 of FIGS. 1 through 4 according to the present embodiment may be a metallic piece 62 formed on the upper portion of the coil 50. The metallic piece 62 may be fixed to the coil 50 by an adhesive in order to prevent separation therebetween.

Also, a flexible metallic thin film may be used in a manner such that it is adhesively fixed to the inner circumferential surface of the coil 50.

Modified Examples of Magnetic Flux Collecting Part

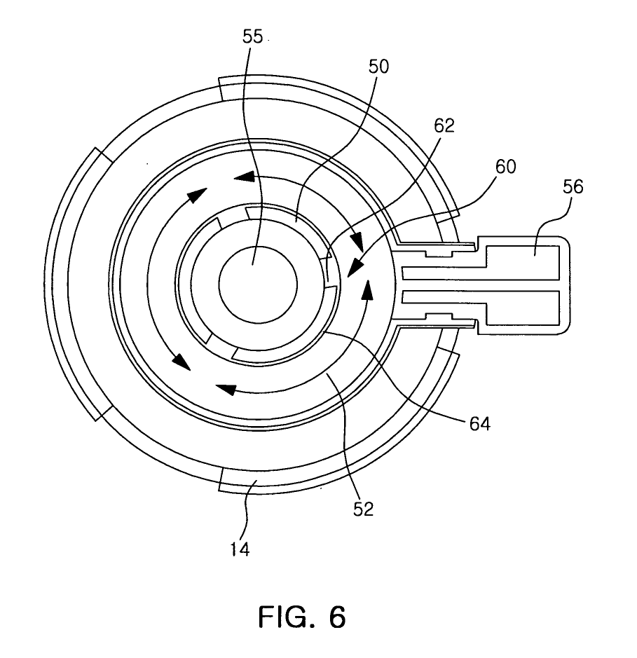

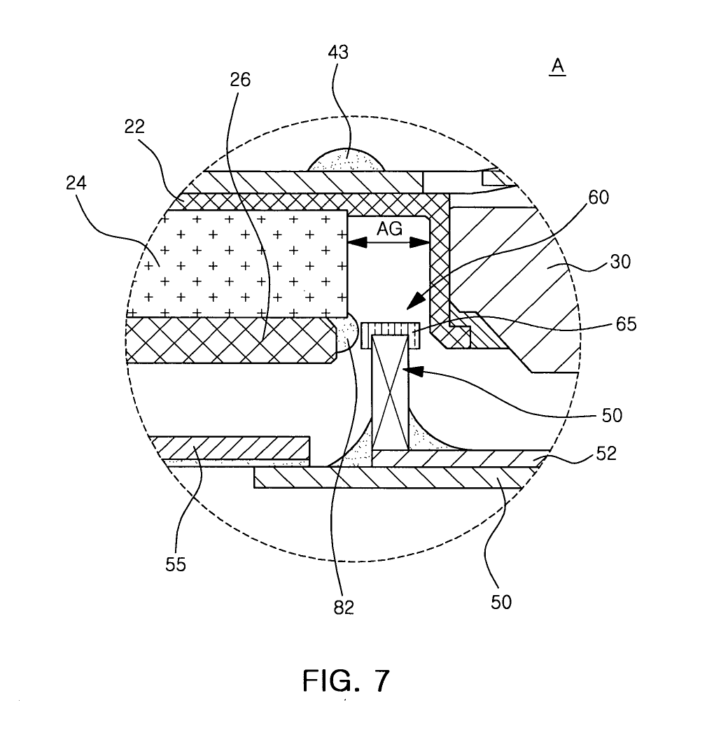

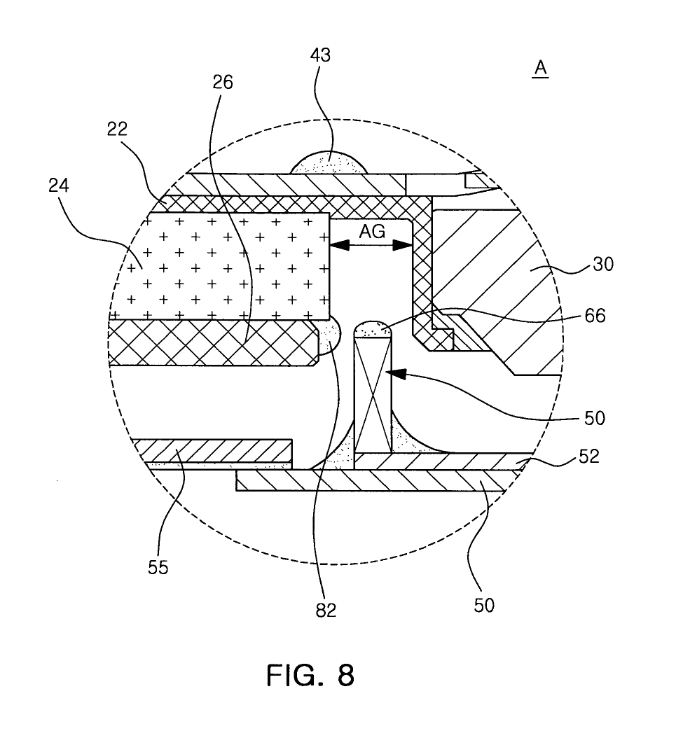

FIG. 6 is a plan view of the linear vibrator of FIG. 1 to which a first modified example of a magnetic flux collecting part provided on a coil is applied. FIG. 7 is an enlarged cross-sectional view of portion A of FIG. 2 illustrating a second modified example of a magnetic flux collecting part provided on a coil. FIG. 8 is an enlarged cross-sectional view of portion A of FIG. 2 illustrating a third modified example of a magnetic flux collecting part provided on a coil.

The magnetic flux collecting part 60 of FIG. 6 may be a plurality of metallic pieces 62 formed on the ring-shaped rim portion 64 fixed to the coil 50. The rim portion 64 may be fixed to the coil 50 by an adhesive or another coupling portion.

Here, the metallic pieces 62 may be disposed on the rim portion 64 having uniform or non-uniform intervals therebetween. The metallic pieces 62 may cause eccentricity in the magnetic flux from the magnetic field part 20 to the coil 50.

The magnetic flux collecting part 60 of FIG. 7 may be a metallic piece 65 in which both side portions thereof are forcibly fitted around the coil 50.

In addition, the metallic piece 62 may also be fixed to the coil 50 by an adhesive for tight bonding.

The magnetic flux collecting part 60 of FIG. 8 may include magnetic liquid 66 fixedly applied to the coil 50. The magnetic liquid 66 may be a mixture of magnetic powder and an adhesive serving as a binder, but is not limited thereto.

Also, the magnetic flux collecting part 60 may be fixed to the coil 50 through only the use of magnetic powder.

Electronic Device

FIG. 10 is an exploded perspective view schematically illustrating an electronic device including a linear vibrator according to an exemplary embodiment of the present invention.

The internal configuration of the linear vibrator 1 according to the embodiment of the invention may be applicable to various electronic devices requiring vibrations as well as a structure requiring vibrations such as a speaker.

With reference to FIG. 10, the electronic device 100 according to an exemplary embodiment of the invention may include the linear vibrator 1, a case 120, and the circuit board 110.

The linear vibrator 1 may be mounted on the circuit board 110 disposed in the internal space of the case 120 through the use of various methods. The connection terminal portion 56 of the linear vibrator 1 and a connection terminal portion 112 of the circuit board 110 are connected to exchange signals.

As set forth above, in a linear vibrator according to exemplary embodiments of the invention, when vibrations are generated in a vibrator (a magnetic field part) hung within an internal space due to external impacts, the vibrating magnetic field part makes contact with a coil, and thus minute vibrations generated in the magnetic field part can be rapidly removed.

Also, since the minute vibrations caused by the external impacts are rapidly removed, this contributes to a reduction of noise and a reduction of interference between components, thereby achieving reliability in terms of durability.

Furthermore, when magnetic fluid is injected between the magnetic field part and the interfering component in order to relieve an impact therebetween, minute vibrations can be reduced by a magnetic flux collecting part, whereby damping performance can be improved even when a small amount of magnetic fluid is injected.

In addition, since the amount of the magnetic fluid is reduced, improved characteristics of the vibrator in relation to an amount of vibrations can be obtained.

While the present invention has been shown and described in connection with the exemplary embodiments, it will be apparent to those skilled in the art that modifications and variations can be made without departing from the spirit and scope of the invention as defined by the appended claims.

What is claimed is:

1. A linear vibrator comprising:
a housing providing an internal space;
a magnetic field part having a yoke disposed in the internal space and a magnet magnetized on a surface of the yoke and vibrating in the internal space by an interaction with a coil to which power is applied;
an elastic member connecting the yoke and the housing and allowing the magnetic field part to be elastically supported in the internal space; and
a magnetic flux collecting part collecting magnetic flux of the magnetic field part and allowing the magnetic field part to move towards the coil.

2. The linear vibrator of claim 1, further comprising a coil damping portion provided between the coil and the magnet and relieving an impact generated when the magnetic field part and the coil are in contact with each other due to magnetic action of the magnetic flux collecting part.

3. The linear vibrator of claim 2, wherein the coil damping portion comprises a magnetic fluid band formed along an outer surface of the magnet.

4. The linear vibrator of claim 1, wherein the coil is wound so as to form a space in which the magnetic field part vibrates and moves, and
the magnetic flux collecting part is provided on the coil.

5. The linear vibrator of claim 1, wherein the magnetic flux collecting part comprises a metallic piece and is adhesively fixed to an upper portion or inner circumferential surface of the coil.

6. The linear vibrator of claim 1, wherein the coil is shaped as a cylinder so as to form a space in which the magnetic field part vibrates and moves, and
the magnetic flux collecting part comprises a plurality of metallic pieces formed on a ring-shaped rim portion fixed to the coil.

7. The linear vibrator of claim 1, wherein the magnetic flux collecting part comprises magnetic powder and is adhesively fixed to an upper portion or inner circumferential surface of the coil.

8. The linear vibrator of claim 1, wherein the magnetic flux collecting part comprises magnetic liquid and is adhesively fixed to an upper portion or inner circumferential surface of the coil.

9. The linear vibrator of claim 1, wherein the coil is shaped as a cylinder so as to form a space in which the magnetic field part vibrates and moves, and
the magnetic flux collecting part is forcibly fitted around the coil.

10. The linear vibrator of claim 1, wherein the yoke comprises:
a magnet fixing portion having the magnet fixed thereto;
a mass body fixing portion bent from the magnet fixing portion in a direction in which the magnet is magnetized and having a mass body fixed thereto; and
a claw portion bent from the mass body fixing portion and supporting a lower portion of the mass body.

11. The linear vibrator of claim 1, wherein the housing comprises:
an upper case shaped as a cylinder having an open lower portion; and
a bracket sealing the lower portion of the upper case and having the coil magnetized thereon.

12. The linear vibrator of claim 1, wherein the magnetic field part further comprises a yoke plate fixed to a surface of the magnet opposite to a surface thereof in contact with the yoke and preventing magnetic leakage.

13. The linear vibrator of claim 1, wherein the housing comprises a bracket damper on a surface thereof, the bracket damper preventing the magnetic field part from making contact with the housing due to vibrations of the magnetic field part.

14. A linear vibrator comprising:
an upper case shaped as a cylinder having an open lower portion;
a bracket fixed to the open lower portion of the upper case to form an internal space and having a coil fixed thereto, the coil receiving power applied thereto from an external source;
a magnetic field part including a yoke disposed in the internal space, a magnet magnetized on a surface of the yoke, and a yoke plate provided on a surface of the magnet opposite to a surface thereof in contact with the yoke, and vibrating in a space within the coil;
an elastic member connecting the upper case and the yoke and allowing the magnetic field part to be elastically supported in the internal space; and
a magnetic flux collecting part collecting magnetic flux of the magnetic field part while breaking a balance of the magnetic flux from the magnetic field part to the coil, and provided on part of an upper portion or inner surface of the coil.

15. The linear vibrator of claim 14, further comprising a magnetic fluid band provided along an outer surface of the magnet and relieving an impact generated when the magnetic field part and the coil are in contact with each other due to magnetic action of the magnetic flux collecting part.

16. The linear vibrator of claim 14, wherein the magnetic flux collecting part comprises a metallic piece adhesively fixed to the coil.

17. The linear vibrator of claim 14, wherein the magnetic flux collecting part comprises a plurality of metallic pieces formed on a ring-shaped rim portion fixed to the coil, and
the metallic pieces cause eccentricity in the magnetic flux.

18. The linear vibrator of claim 14, wherein the magnetic flux collecting part comprises magnetic powder adhesively fixed to the coil.

19. The linear vibrator of claim 14, wherein the magnetic flux collecting part comprises magnetic liquid fixedly applied to the coil.

20. The linear vibrator of claim 14, wherein the magnetic flux collecting part comprises a metallic piece forcibly fitted around the coil.

21. The linear vibrator of claim 14, wherein the yoke comprises:
a magnet fixing portion having the magnet fixed thereto;
a mass body fixing portion bent from the magnet fixing portion in a direction in which the magnet is magnetized and having a mass body fixed thereto; and
a claw portion bent from the mass body fixing portion and supporting a lower portion of the mass body.

22. The linear vibrator of claim 14, further comprising a bracket damper provided on the bracket so as to prevent the magnetic field part from making contact with the bracket due to vibrations of the magnetic field part.

23. An electronic device comprising:
the linear vibrator according to claims 1;
a circuit board having the linear vibrator mounted thereon; and
a case having the circuit board in an internal space thereof.

24. An electronic device comprising:
the linear vibrator according to claims 14;
a circuit board having the linear vibrator mounted thereon; and
a case having the circuit board in an internal space thereof.
